(19) United States
(12) Patent Application Publication
(10) Pub. No.: US 2026/0307581 A1
(43) Pub. Date: Oct. 8, 2026

(54) TRAJECTORY PRESENTATION DEVICE

(71) Applicant: TOYOTA JIDOSHA KABUSHIKI KAISHA, Toyota-shi (JP)

(72) Inventor: Masato OKUDA, Okazaki-shi (JP)

(73) Assignee: TOYOTA JIDOSHA KABUSHIKI KAISHA, Toyota-shi (JP)

(21) Appl. No.: 19/551,965

(22) Filed: Feb. 27, 2026

(30) Foreign Application Priority Data
Apr. 4, 2025 (JP) 2025-062431

(51) Int. Cl. B60Q 1/08; B60K 35/28; B60W 50/00; B60W 50/14; G06V 20/58

(52) U.S. Cl. CPC B60Q 1/085; B60K 35/28; B60W 50/0097; B60W 50/14; G06V 20/58; B60K 2360/176; B60K 2360/1868; B60Q 2300/45; B60W 2050/146; B60W 2420/403; B60W 2540/18; B60W 2554/4041; B60W 2554/80

(57) ABSTRACT

The trajectory presentation device emits trajectory guide light corresponding to a vehicle body trajectory of a host vehicle. The trajectory presentation device includes a projector that can emit trajectory guide light, an obstacle detection unit that detects an obstacle, a trajectory prediction unit that predicts a vehicle body trajectory of a host vehicle, and an irradiation control unit that emits the trajectory guide light corresponding to the vehicle body trajectory to a traveling road surface using the projector. The irradiation control unit emits the trajectory guide light to the traveling road surface and the obstacle in a case where the obstacle is positioned on the vehicle body trajectory.

### CROSS-REFERENCE TO RELATED APPLICATION

This application claims priority to Japanese Patent Application No. 2025-062431 filed on Apr. 4, 2025. The disclosure of the above-identified application, including the specification, drawings, and claims, is incorporated by reference herein in its entirety.

### BACKGROUND

### 1. Technical Field

The present disclosure relates to a trajectory presentation device that emits trajectory guide light corresponding to a vehicle body trajectory of a host vehicle.

### 2. Description of Related Art

Various trajectory presentation devices that present a traveling path of a vehicle have been proposed. For example, Japanese Unexamined Patent Application Publication No. 2018-118618 (JP 2018-118618 A) discloses a device that predicts a vehicle body trajectory along which a vehicle body of a host vehicle passes based on a traveling path of the host vehicle and presents the traveling path by emitting light along the vehicle body trajectory.

### SUMMARY

Various obstacles are present around a vehicle. Therefore, the obstacle may be positioned on a predicted vehicle body trajectory, and the vehicle may come into contact with the obstacle. For example, in the device disclosed in the above document, an irradiation of light in a case where the obstacle is positioned on the predicted vehicle body trajectory is not considered.

Therefore, the present disclosure describes a trajectory presentation device that can emit trajectory guide light corresponding to a vehicle body trajectory of a host vehicle in consideration of a possibility of contact with an obstacle around the host vehicle.

A trajectory presentation device according to an aspect of the present disclosure is,

[1] “A trajectory presentation device that emits trajectory guide light corresponding to a vehicle body trajectory along which a vehicle body of a host vehicle passes during traveling of the host vehicle in a vicinity of the host vehicle, the trajectory presentation device includes

a projector configured to emit the trajectory guide light in the vicinity of the host vehicle,

an obstacle detection unit configured to detect an obstacle in the vicinity of the host vehicle,

a steering acquisition unit configured to acquire a steering input value of a steering operation of the host vehicle,

a trajectory prediction unit configured to predict the vehicle body trajectory of the host vehicle based on the steering input value, and

an irradiation control unit configured to emit, using the projector, the trajectory guide light corresponding to the vehicle body trajectory onto a traveling road surface in the vicinity of the host vehicle,

in which the irradiation control unit is configured to emit the trajectory guide light corresponding to the vehicle body trajectory onto the traveling road surface of the host vehicle and onto the obstacle in a case where the obstacle detected by the obstacle detection unit is positioned on the vehicle body trajectory”.

The trajectory presentation device may be,

[2] “The trajectory presentation device according to [1], in which

the obstacle positioned on the vehicle body trajectory, which is detected by the obstacle detection unit, is an object that enters the vehicle body trajectory from a side of the vehicle body trajectory in a state of being spaced apart from the traveling road surface, and

the irradiation control unit is configured to emit the trajectory guide light onto a portion of the obstacle that enters the vehicle body trajectory”.

The trajectory presentation device may be,

[3] “The trajectory presentation device according to [1] or [2], in which the irradiation control unit is configured to emit the trajectory guide light corresponding to the vehicle body trajectory onto the traveling road surface of the host vehicle and onto the obstacle by changing an irradiation direction of a light source provided in the projector or switching, among a plurality of light sources disposed in the projector such that the light sources have different irradiation directions, the light source to emit the trajectory guide light”.

The trajectory presentation device may be,

[4] “The trajectory presentation device according to any one of [1] to [3], in which the irradiation control unit does not emit the trajectory guide light in a case where the obstacle detected by the obstacle detection unit is a person and the person is positioned within a distance that is predetermined from the host vehicle”.

The trajectory presentation device may be,

[5] “The trajectory presentation device according to any one of [1] to [4], further includes

a camera configured to capture an image of the vicinity of the host vehicle, and

a display configured to display the image captured by the camera, in which

the projector is configured to emit the trajectory guide light at a wavelength different from visible light, and

the camera is configured to detect the wavelength of the trajectory guide light emitted by the projector”.

According to an aspect of the present disclosure, it is possible to emit trajectory guide light corresponding to a vehicle body trajectory of a host vehicle in consideration of a possibility of contact with an obstacle around the host vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a trajectory presentation device according to a first embodiment;

FIG. 2A is a side view of trajectory guide light emitted from a projector to a front side of a host vehicle as viewed from a side of the host vehicle;

FIG. 2B is a diagram of the trajectory guide light emitted from the projector to the front side of the host vehicle as viewed from a vehicle cabin of the host vehicle;

FIG. 3 is a diagram of the trajectory guide light emitted from the projector to the front side of the host vehicle as viewed from a vehicle cabin of the host vehicle;

FIG. 4A is a top view showing a positional relationship between the host vehicle and a vehicle positioned in front of the host vehicle;

FIG. 4B is a diagram of the trajectory guide light emitted from the projector to the front side of the host vehicle as viewed from a vehicle cabin of the host vehicle;

FIG. 5 is a flowchart showing a flow of irradiation processing of the trajectory guide light performed in the trajectory presentation device;

FIG. 6 is a block diagram showing an example of a trajectory presentation device according to a second embodiment;

FIG. 7 is a diagram of the trajectory guide light emitted from the projector to the front side of the host vehicle as viewed from the vehicle cabin of the host vehicle; and

FIG. 8 is a flowchart showing a flow of the irradiation processing of the trajectory guide light performed in the trajectory presentation device.

### DETAILED DESCRIPTION OF EMBODIMENTS

Hereinafter, exemplary embodiments will be described with reference to the drawings. In each drawing, the same or corresponding elements are designated by the same reference numerals, and redundant description thereof will be omitted.

### First Embodiment

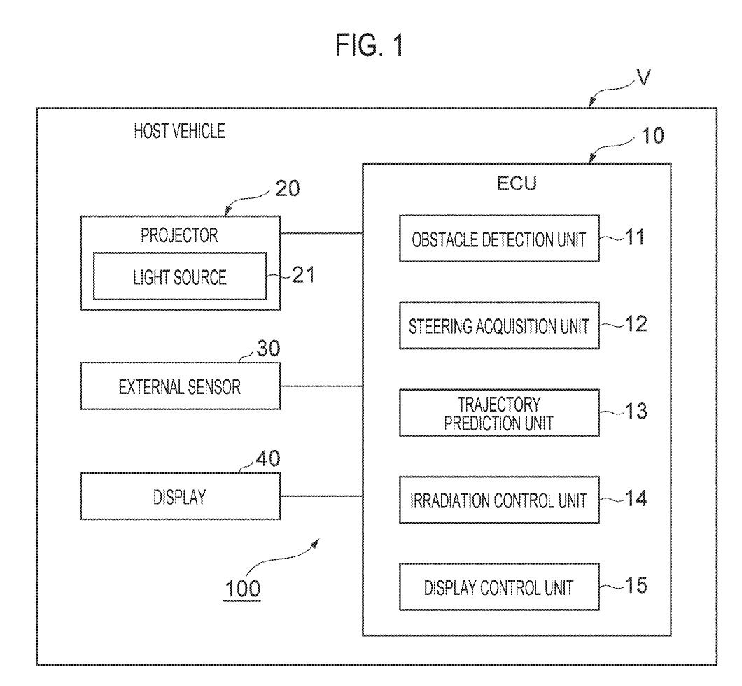

First, a first embodiment of a trajectory presentation device will be described. As shown in FIG. 1, a trajectory presentation device 100 according to the first embodiment is mounted in a host vehicle V. The trajectory presentation device 100 emits trajectory guide light corresponding to a vehicle body trajectory along which a vehicle body of the host vehicle V passes during traveling of the host vehicle V in a vicinity of the host vehicle V. The vehicle body trajectory along which the vehicle body of the host vehicle V passes during traveling of the host vehicle V indicates a range through which the vehicle body of the host vehicle V passes during traveling of the host vehicle V. The vehicle body trajectory indicates a range through which the vehicle body of the host vehicle V passes in a case where the host vehicle V travels based on a traveling trajectory that is predicted.

The trajectory guide light corresponding to the vehicle body trajectory is light that is emitted based on the vehicle body trajectory to indicate the range through which the vehicle body of the host vehicle V passes. A shape of the trajectory guide light corresponding to the vehicle body trajectory is set based on the vehicle body trajectory of the host vehicle V. The shape of the trajectory guide light that is emitted is not limited as long as the vehicle body trajectory can be indicated. In the present embodiment, as an example, the trajectory guide light is emitted a plurality of times at predetermined intervals along positions of both end parts of the vehicle body trajectory in a vehicle width direction (edge parts of both end parts of the vehicle body trajectory in the vehicle width direction), and a dotted guide mark is displayed on a traveling road surface.

The trajectory presentation device 100 includes an electronic control unit (ECU) 10 that integrally manages the device. The ECU 10 is an electronic control unit having a central processing unit (CPU) and a storage unit. The storage unit is configured of, for example, a read only memory (ROM), a random access memory (RAM), and an electrically erasable programmable read-only memory (EEPROM). The ECU 10 realizes various functions by executing a program stored in the storage unit with the CPU. The ECU 10 may be configured of a plurality of electronic control units.

The trajectory presentation device 100 further includes a projector 20, an external sensor (camera) 30, and a display 40. The projector 20, the external sensor 30, and the display 40 are connected to the ECU 10. These devices connected to the ECU 10 are mounted in the host vehicle V.

The projector 20 can emit the trajectory guide light in the vicinity of the host vehicle V. The projector 20 emits the trajectory guide light corresponding to the vehicle body trajectory to the traveling road surface of the host vehicle V. In the present embodiment, the projector 20 is provided at a front end part of the host vehicle V, for example, to indicate the vehicle body trajectory during forward movement of the host vehicle V. The projector 20 is provided at a rear end part of the host vehicle V, for example, to indicate the vehicle body trajectory during reverse movement of the host vehicle V.

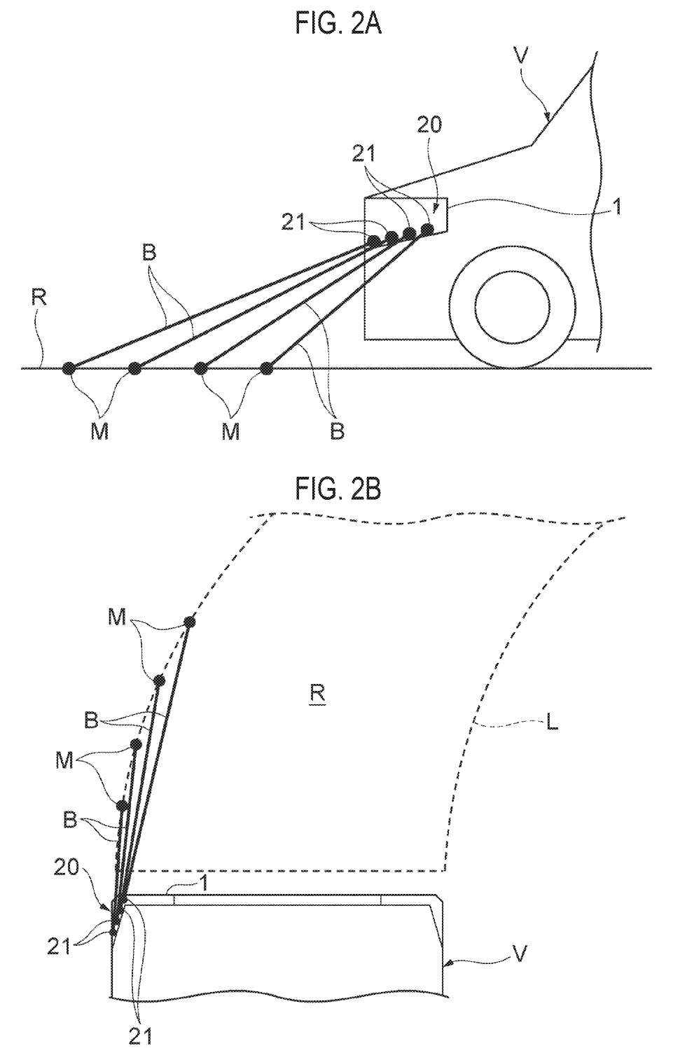

For example, as shown in FIGS. 2A and 2B, the projector 20 may be provided in a headlamp 1 provided at the front end part of the host vehicle V to indicate the vehicle body trajectory during forward movement of the host vehicle V. In addition, the projector 20 includes a light source 21. The projector 20 may include a plurality of light sources 21. The light source 21 emits trajectory guide light B. The light source 21 is movable and can change an irradiation direction of the trajectory guide light B. The projector 20 emits the trajectory guide light B to a traveling road surface R of the host vehicle V using the light source 21. The projector 20 emits the trajectory guide light B along positions of both end parts of a vehicle body trajectory L of the host vehicle V in the vehicle width direction (edge parts of both end parts of the vehicle body trajectory L in the vehicle width direction) in response to an instruction from the ECU 10. As a result, the guide mark M is displayed on the traveling road surface R by emitting the trajectory guide light B to the traveling road surface R. The guide mark M is a mark (reflected light of the trajectory guide light B) displayed on the traveling road surface R by emitting the trajectory guide light B to the traveling road surface R.

As described above, in the present embodiment, the projector 20 emits the trajectory guide light B such that the guide mark M appears in a dotted pattern along the positions of both end parts of the vehicle body trajectory L in the vehicle width direction. The projector 20 displays a plurality of guide marks M in a dotted pattern along the positions of both end parts of the vehicle body trajectory L in the vehicle width direction using the plurality of light sources 21. In FIGS. 2A and 2B, the guide mark M has a circular shape, but the shape of the guide mark M is not limited. The guide mark M may have a short linear shape extending along a longitudinal direction of the vehicle body trajectory L. In addition, in FIGS. 2A and 2B, a case is shown in which the projector 20 is provided in the headlamp 1 on the left side of the host vehicle V and the trajectory guide light B is emitted along a position of an end part of the vehicle body trajectory L on the left side in the vehicle width direction. Similarly to the left side, the trajectory presentation device 100 is provided with a projector in the headlamp on the right side and emits the trajectory guide light along a position of an end part of the vehicle body trajectory L on the right side in the vehicle width direction. In addition, the number of light sources 21 provided in the projector 20 is not limited. For example, the number of light sources 21 provided in the projector 20 may be one. In this case, for example, the projector 20 may sequentially emit the trajectory guide light B from a position close to the host vehicle V by sequentially controlling an orientation of the projector 20, and display the guide mark M in a dotted pattern along the positions of both end parts of the vehicle body trajectory L in the vehicle width direction.

The external sensor 30 is an in-vehicle sensor that detects an external environment of the host vehicle V. The external sensor 30 includes at least a camera. The camera is a capturing device that captures an image of the external environment of the host vehicle V. The camera is provided, for example, behind a windshield of the host vehicle V and captures the image of a vehicle front side. The camera transmits capturing information related to the external environment of the host vehicle V to the ECU 10. The camera may be a monocular camera or a stereo camera. A plurality of cameras may be provided, and the camera may capture the image of a left side, a right side, a rear side, or the like of the host vehicle V in addition to the front side of the host vehicle V.

The external sensor 30 may include a radar sensor. The radar sensor is a detection device that detects an object around the host vehicle V by using radio waves (for example, millimeter waves) or light. The radar sensor includes, for example, a millimeter wave radar or a light detection and ranging (LIDAR). The radar sensor detects an object by transmitting radio waves or light in the vicinity of the host vehicle V and receiving the radio waves or light reflected by the object. The radar sensor transmits the detected object information to the ECU 10. In addition, the external sensor 30 may include a sonar sensor.

The external sensor 30 can capture an image of the guide mark M displayed on the traveling road surface R or the like by the irradiation with the trajectory guide light B in a case where the trajectory guide light B is emitted to the traveling road surface R or the like by the projector 20.

The display 40 is an interface that presents information to the host vehicle V and a driver (occupant). The display 40 displays a captured image by the camera included in the external sensor 30.

Functionally, the ECU 10 includes an obstacle detection unit 11, a steering acquisition unit 12, a trajectory prediction unit 13, an irradiation control unit 14, and a display control unit 15.

The obstacle detection unit 11 detects an obstacle around the host vehicle V based on a detection result of the external sensor 30. The obstacle detected by the obstacle detection unit 11 includes an obstacle positioned on the vehicle body trajectory L of the host vehicle V (positioned in the vehicle body trajectory L). In addition, the obstacle positioned on the vehicle body trajectory L, which is detected by the obstacle detection unit 11, includes an object that enters the vehicle body trajectory L from a side of the vehicle body trajectory L in a state of being raised from the traveling road surface R. The obstacle includes a fixed obstacle such as a utility pole or a road sign, another vehicle, a person, a bicycle, and the like. The obstacle detection unit 11 can detect the obstacle by various known methods based on the detection result of the external sensor 30.

The steering acquisition unit 12 acquires a steering input value of a steering operation of the host vehicle V. The steering operation is an operation of steering (operation of a steering wheel) performed by the driver of the host vehicle V. The steering input value is a value indicating a steering angle. For example, the steering acquisition unit 12 may acquire a detection result of a steering sensor that acquires a rotation angle of a steering shaft connected to the steering wheel, as the steering input value. In a case where the host vehicle V is an autonomous driving vehicle, the steering acquisition unit 12 may acquire a steering instruction value in a case where an autonomous driving control unit causes the host vehicle V to travel by autonomous driving, as the steering input value.

The trajectory prediction unit 13 predicts the vehicle body trajectory L in a case where the host vehicle V travels, based on the steering input value acquired by the steering acquisition unit 12. The trajectory prediction unit 13 can predict the vehicle body trajectory L based on information such as a vehicle width of the host vehicle V, which is stored in advance, and the steering input value acquired by the steering acquisition unit 12. That is, the vehicle body trajectory L predicted by the trajectory prediction unit 13 varies in curvature depending on the steering angle, for example.

The irradiation control unit 14 emits the trajectory guide light B corresponding to the vehicle body trajectory L predicted by the trajectory prediction unit 13 to the traveling road surface R around the host vehicle V using the projector 20. As described above, the irradiation control unit 14 emits the trajectory guide light B using the projector 20 such that the guide mark M is displayed in a dotted pattern along the positions of both end parts of the vehicle body trajectory L in the vehicle width direction (see FIG. 2B). The irradiation control unit 14 changes an orientation (irradiation direction of the trajectory guide light B) of the light source 21 provided in the projector 20 such that the guide mark M appears in a dotted pattern along the positions of both end parts of the vehicle body trajectory L in the vehicle width direction. As a result, the irradiation control unit 14 emits the trajectory guide light B corresponding to the vehicle body trajectory L using the projector 20.

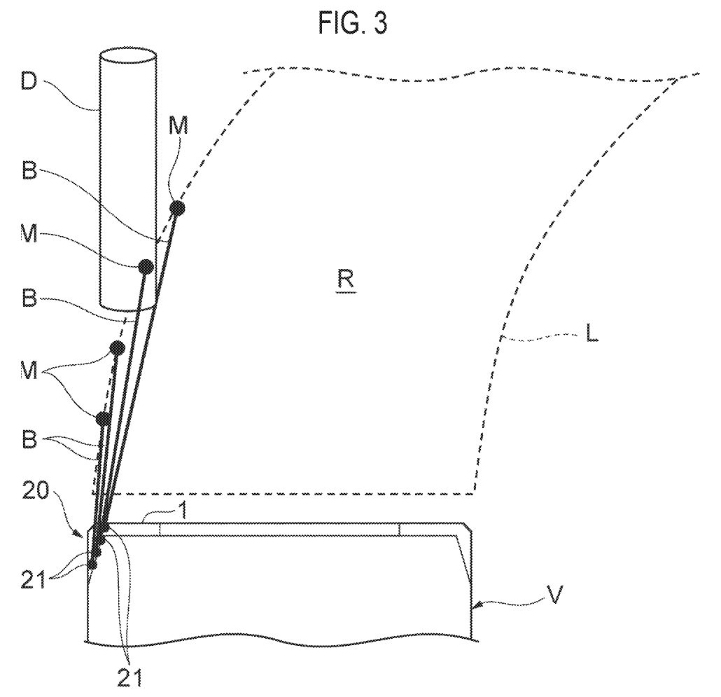

In addition, in a case where the obstacle detected by the obstacle detection unit 11 is positioned on the vehicle body trajectory L, the irradiation control unit 14 emits the trajectory guide light B corresponding to the vehicle body trajectory L to the traveling road surface R and the detected obstacle. For example, as shown in FIG. 3, an obstacle D such as a utility pole may be positioned on the vehicle body trajectory L (in the vehicle body trajectory L). In this case, the irradiation control unit 14 emits the trajectory guide light B to the obstacle D. In a case where none of the plurality of trajectory guide lights B emitted by the irradiation control unit 14 is emitted to the obstacle D, the irradiation control unit 14 can control an orientation of at least one of the plurality of light sources 21 such that the trajectory guide light B is emitted to the obstacle D. Whether the trajectory guide light B is emitted to the obstacle D can be determined based on, for example, the captured image by the camera provided in the external sensor 30. In addition, whether the trajectory guide light B is emitted to the obstacle D may be determined based on the position of the detected obstacle D and the orientation of each light source 21.

The irradiation control unit 14 emits the trajectory guide light B to a portion of the obstacle D that enters the vehicle body trajectory L. The trajectory guide light B may be emitted to the obstacle D. In this case, the irradiation control unit 14 may emit the trajectory guide light B such that the guide mark M is displayed at a higher position on a side surface of the obstacle D. That is, the irradiation control unit 14 may emit the trajectory guide light B slightly upward (upward by a predetermined angle) as compared with a case of emitting the trajectory guide light B toward the edge part of the vehicle body trajectory L. In this case, the irradiation control unit 14 may emit the trajectory guide light B slightly outward (outward by a predetermined length) from the edge part of the vehicle body trajectory L such that the guide mark M is displayed at a higher position on the side surface of the obstacle D. In this case, the occupant (driver) of the host vehicle V can easily determine that the host vehicle V may come into contact with the obstacle D.

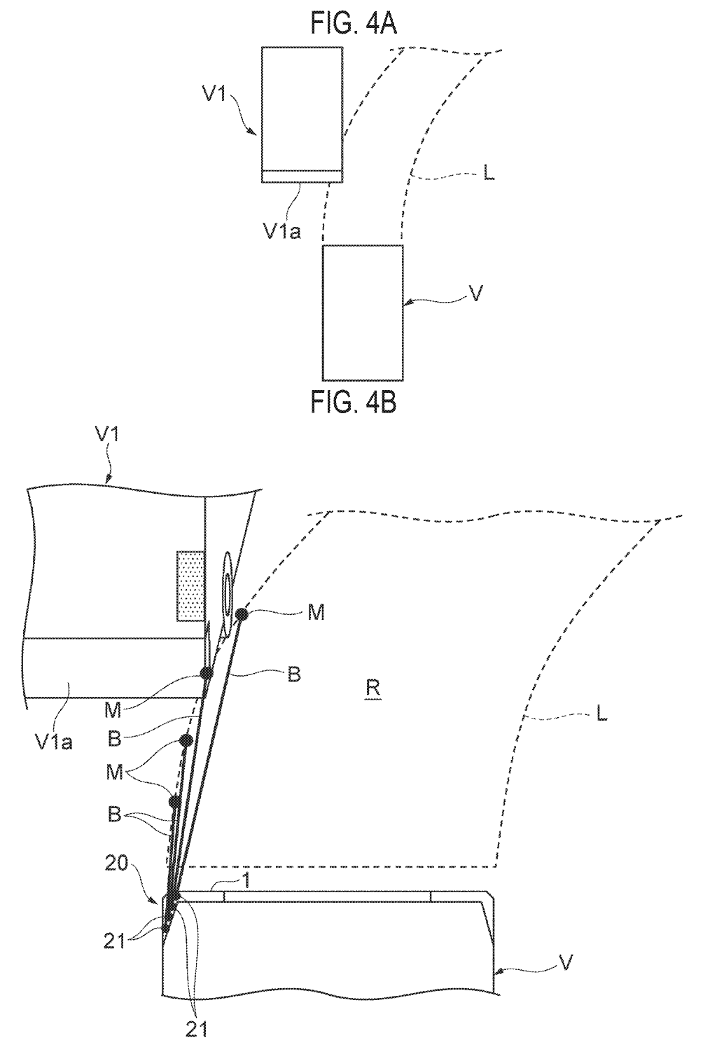

For example, as shown in FIG. 4A, another vehicle V1 that is parked in front of the host vehicle V may be present as the obstacle around the host vehicle V. In addition, a right side portion of a rear bumper V1a of the other vehicle V1 enters the vehicle body trajectory L of the host vehicle V. The rear bumper V1a is raised from the traveling road surface R. In addition, the right side portion of the rear bumper V1a enters the vehicle body trajectory L from the left side of the vehicle body trajectory L in a state of being raised from the traveling road surface R. In this case, the irradiation control unit 14 emits the trajectory guide light B to a portion (right side portion of the rear bumper V1a) of the rear bumper V1a of the other vehicle V1 that enters the vehicle body trajectory L. The irradiation control unit 14 controls an irradiation direction of the trajectory guide light B such that the trajectory guide light B is emitted to the right side portion of the rear bumper V1a that is raised from the traveling road surface R. The trajectory guide light B may be emitted to the right side portion of the rear bumper V1a. In this case, the irradiation control unit 14 may emit the trajectory guide light B slightly upward as compared with a case of emitting the trajectory guide light B toward the edge part of the vehicle body trajectory L such that the guide mark M is displayed at a higher position on the side surface of the right side portion of the rear bumper V1a.

As described above, the trajectory presentation device 100 emits the trajectory guide light B such that the right side portion of the rear bumper V1a that enters the vehicle body trajectory L is irradiated with the trajectory guide light B in a case where the rear bumper V1a of the other vehicle V1 is raised from the traveling road surface R. The occupant (driver) of the host vehicle V may be positioned on the vehicle body trajectory L in a state where the obstacle is raised from the traveling road surface R as in the right side portion of the rear bumper V1a of the other vehicle V1. Even in this case, it is possible to easily determine that the host vehicle V may come into contact with the obstacle (for example, the right side portion of the rear bumper V1a of the other vehicle V1).

In a case where the obstacle detected by the obstacle detection unit 11 includes a person (a pedestrian, a person riding a bicycle, or the like) and the person is positioned within a predetermined distance from the host vehicle V, the irradiation control unit 14 does not emit the trajectory guide light B. The person who is the target of not performing the irradiation with the trajectory guide light B can be a person positioned on a side where the trajectory guide light B is emitted. For example, in a case of emitting the trajectory guide light B to the front side of the host vehicle V, the trajectory guide light B may not be emitted in a case where a person is detected on the front side of the host vehicle V, and the trajectory guide light B may be emitted in a case where a person is detected on the rear side of the host vehicle V. On the contrary, for example, in a case of emitting the trajectory guide light B to the rear side of the host vehicle V, the trajectory guide light B may not be emitted in a case where a person is detected on the rear side of the host vehicle V, and the trajectory guide light B may be emitted in a case where a person is detected on the front side of the host vehicle V. In this case, the trajectory presentation device 100 can reduce the likelihood that the person around the host vehicle V feels discomfort with the trajectory guide light B emitted in the vicinity of the host vehicle V.

In addition, in a case where the irradiation with the trajectory guide light B is instructed to be stopped by the occupant (driver or the like) of the host vehicle V, the irradiation control unit 14 does not emit the trajectory guide light B. In this case, the trajectory presentation device 100 can control whether to emit the trajectory guide light B based on the instruction from the occupant of the host vehicle V. In addition, even in a case of emitting the trajectory guide light B, the irradiation control unit 14 may emit the trajectory guide light B only in the vicinity of the host vehicle V in order to prevent the trajectory guide light B from entering the eyes of the person around the host vehicle V, the occupant of the other vehicle, or the like.

The display control unit 15 displays the captured image by the camera included in the external sensor 30 on the display 40. In a case where the trajectory guide light B is emitted from the projector 20, the guide mark M displayed by the irradiation with the trajectory guide light B is also displayed on the display 40. As a result, the occupant of the host vehicle V can determine the possibility of contact with the obstacle around the host vehicle V by directly visually recognizing the guide mark M of the trajectory guide light B emitted from the projector 20. In addition, the occupant of the host vehicle V can determine the possibility of contact with the obstacle around the host vehicle V by visually recognizing the captured image including the guide mark M displayed on the display 40.

In addition, the projector 20 may emit the trajectory guide light B at a wavelength different from visible light that is visible to the person. In this case, the camera of the external sensor 30 is configured to detect the wavelength of the trajectory guide light B emitted by the projector 20. As a result, the camera can capture the image of the guide mark M of the trajectory guide light B that is emitted at a wavelength different from visible light. Then, the display control unit 15 displays the captured image by the camera on the display 40. In this case, the occupant can determine the possibility of contact with the obstacle around the host vehicle V by visually recognizing the captured image including the guide mark M displayed on the display 40 even in a case where the trajectory guide light B is emitted at a wavelength different from visible light. In addition, since the person around the host vehicle V cannot visually recognize the trajectory guide light B, it is possible to reduce the likelihood that the person around the host vehicle V feels discomfort with the trajectory guide light B that is emitted.

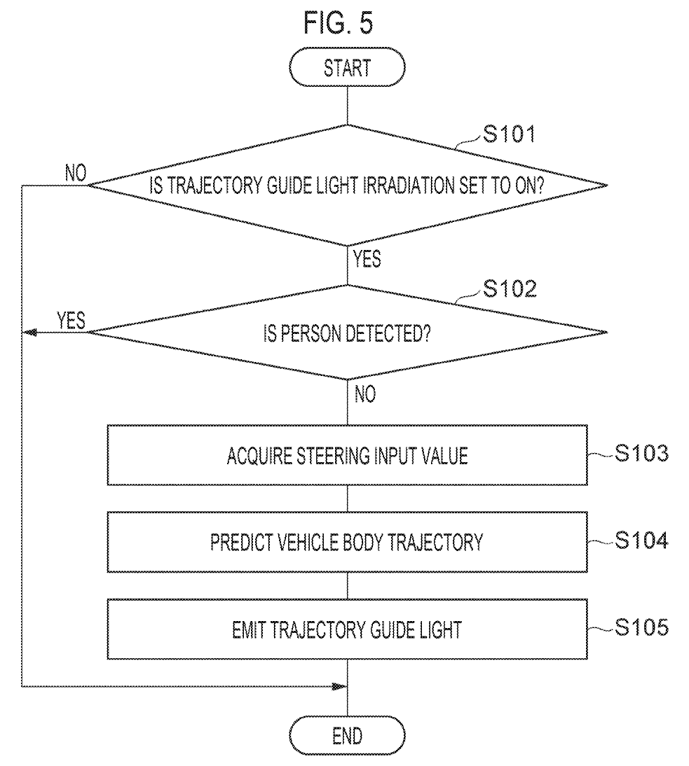

Next, a flow of the irradiation processing of the trajectory guide light B performed in the trajectory presentation device 100 will be described. The processing shown in FIG. 5 is started, for example, in a case where an ignition switch of the host vehicle V is turned on. In addition, in a case where the processing shown in FIG. 5 ends, the processing is started again from the start after a predetermined time. As shown in FIG. 5, in a case where the irradiation processing of the trajectory guide light B is started, the irradiation control unit 14 determines whether the irradiation with the trajectory guide light B is instructed (irradiation ON setting) by the occupant (driver or the like) of the host vehicle V (S101). In a case where the irradiation with the trajectory guide light B is not instructed, that is, in a case where the instruction to stop the irradiation with the trajectory guide light B is given (S101: NO), the processing proceeds to the end.

In a case where the irradiation with the trajectory guide light B is instructed (S101: YES), the irradiation control unit 14 determines whether a person is detected around the host vehicle V by the obstacle detection unit 11 (S102). In a case where the person is detected (S102: YES), the processing proceeds to the end. In a case where the person is not detected (S102: NO), the steering acquisition unit 12 acquires the steering input value (S103). The trajectory prediction unit 13 predicts the vehicle body trajectory L in a case where the host vehicle V travels, based on the steering input value acquired by the steering acquisition unit 12 (S104). The irradiation control unit 14 emits the trajectory guide light B corresponding to the vehicle body trajectory L predicted by the trajectory prediction unit 13 to the traveling road surface R around the host vehicle V using the projector 20 (S105). The obstacle detected by the obstacle detection unit 11 may be positioned on the vehicle body trajectory L. In this case, as described above, the irradiation control unit 14 emits the trajectory guide light B to the obstacle positioned on the vehicle body trajectory L.

As described above, in a case where the obstacle detected by the obstacle detection unit 11 is positioned on the vehicle body trajectory L, the trajectory presentation device 100 emits the trajectory guide light B corresponding to the vehicle body trajectory L to the traveling road surface R of the host vehicle V and the obstacle. As a result, the trajectory presentation device 100 can emit the trajectory guide light B corresponding to the vehicle body trajectory L of the host vehicle V in consideration of the possibility of contact with the obstacle around the host vehicle V.

### Second Embodiment

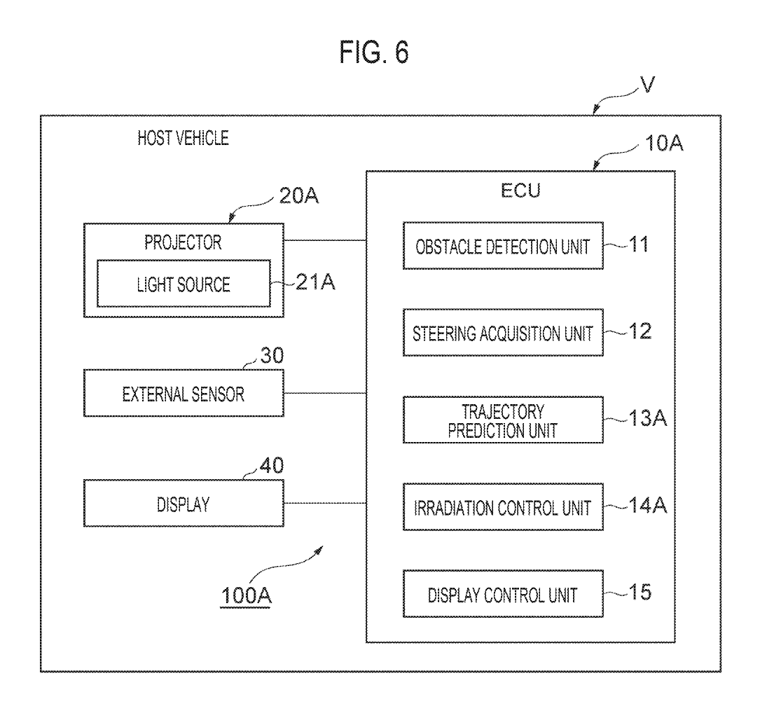

Next, a second embodiment of a trajectory presentation device will be described. Hereinafter, the second embodiment will be described with the differences from the trajectory presentation device 100 according to the first embodiment. As shown in FIG. 6, a trajectory presentation device 100A according to the second embodiment includes an ECU 10A, a projector 20A, an external sensor 30, and a display 40.

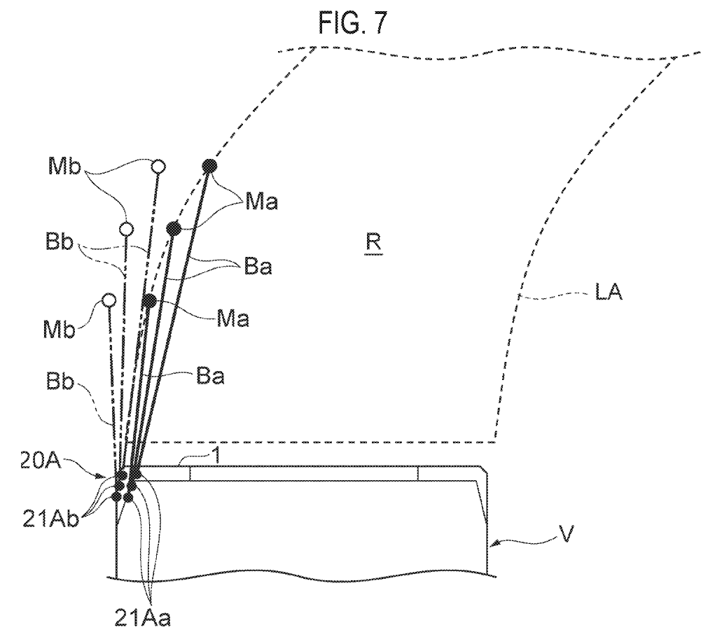

The projector 20A emits the trajectory guide light B as in the projector 20 according to the first embodiment. As shown in FIG. 7, in the present embodiment, the projector 20A includes a plurality of light sources 21A. The orientation of the light source 21A is fixed to the headlamp 1. The plurality of light sources 21A includes a plurality of first light sources 21Aa and a plurality of second light sources 21Ab. The first light source 21Aa emits the trajectory guide light B corresponding to the vehicle body trajectory at the maximum steering angle of the host vehicle V in the vicinity of the host vehicle V. Here, the maximum steering angle of the host vehicle V is a steering angle in a case where the host vehicle V is steered to the maximum in the direction in which the host vehicle V is steered. The vehicle body trajectory at the maximum steering angle of the host vehicle V indicates a range through which the vehicle body of the host vehicle V passes in a case where the host vehicle V is steered to the maximum in the direction in which the host vehicle V is steered.

The vehicle body trajectory at the maximum steering angle of the host vehicle V is referred to as a maximum vehicle body trajectory LA. The trajectory guide light B emitted by the first light source 21Aa is referred to as a first trajectory guide light Ba. The guide mark M displayed by the first trajectory guide light Ba is referred to as a first guide mark Ma. In the present embodiment, the first light source 21Aa emits the first trajectory guide light Ba such that the first guide mark Ma is displayed in a dotted pattern along the positions of both end parts of the maximum vehicle body trajectory LA in the vehicle width direction. That is, the irradiation direction of the first light source 21Aa is set in advance such that the first trajectory guide light Ba can be emitted to a position of an edge part of the maximum vehicle body trajectory LA in a case where the host vehicle V travels at the maximum steering angle.

The second light source 21Ab emits the trajectory guide light B to a position located a predetermined distance outward in the vehicle width direction from the maximum vehicle body trajectory LA of the host vehicle V at the maximum steering angle. The trajectory guide light B emitted by the second light source 21Ab is referred to as a second trajectory guide light Bb. The guide mark M displayed by the second trajectory guide light Bb is referred to as a second guide mark Mb. In the present embodiment, the second light source 21Ab emits the second trajectory guide light Bb such that the second guide mark Mb is displayed in a dotted pattern along the positions of both end parts of the maximum vehicle body trajectory LA in the vehicle width direction at a position that is located a predetermined distance outward in the vehicle width direction from the maximum vehicle body trajectory LA.

That is, the irradiation direction of the second light source 21Ab is set in advance such that the second trajectory guide light Bb can be emitted to a position that is a predetermined distance away from the edge part of the maximum vehicle body trajectory LA in a case where the host vehicle V travels at the maximum steering angle.

For example, as in the example shown in FIGS. 3 and 4B, an obstacle may be present in the vicinity of both end parts of the maximum vehicle body trajectory LA in the vehicle width direction in the present embodiment. In this case, both the first trajectory guide light Ba and the second trajectory guide light Bb can be emitted onto this obstacle. In this case, on the side surface of the obstacle, the second guide mark Mb displayed by the second trajectory guide light Bb is displayed at a higher position than the first guide mark Ma displayed by the first trajectory guide light Ba. In addition, for example, the position of the obstacle may be a position that is not hit by the emitted first trajectory guide light Ba. Even in this case, since the irradiation directions of the first trajectory guide light Ba and the second trajectory guide light Bb are different from each other, the second guide mark Mb can be displayed on the side surface of the obstacle by the second trajectory guide light Bb.

As described above, the plurality of light sources (the first light source 21Aa and the second light source 21Ab) provided in the projector 20A are disposed to have different irradiation directions of the trajectory guide light B. The projector 20A can switch the light source that emits the trajectory guide light B among the plurality of first light sources 21Aa and the second light sources 21Ab in response to an instruction from the ECU 10A.

In FIG. 7, a case is shown in which the projector 20A is provided in the headlamp 1 on the left side of the host vehicle V and the trajectory guide light B (the first trajectory guide light Ba and the second trajectory guide light Bb) is emitted along the end part of the maximum vehicle body trajectory LA on the left side in the vehicle width direction. Similarly to the left side, the trajectory presentation device 100A is provided with a projector in the headlamp on the right side and emits the trajectory guide light along the end part of the maximum vehicle body trajectory LA on the right side in the vehicle width direction. In addition, the number of light sources 21A provided in the projector 20A is not limited. In addition, the projector 20A includes the first light source and the second light source in a case of a left turn, as in the first light source 21Aa and the second light source 21Ab in a case of a right turn. This is because, as shown in FIG. 7, the trajectory guide light can be emitted to the positions of both end parts of the maximum vehicle body trajectory in the vehicle width direction not only in a case of a right turn but also in a case of a left turn.

The ECU 10A includes a trajectory prediction unit 13A and an irradiation control unit 14A that are different in configuration from the trajectory prediction unit 13 and the irradiation control unit 14 of the ECU 10 according to the first embodiment. The trajectory prediction unit 13A predicts the maximum vehicle body trajectory LA based on the steering input value acquired by the steering acquisition unit 12. The trajectory prediction unit 13A predicts a trajectory along which the vehicle body passes in a case where the host vehicle V is steered to the maximum in the direction in which the host vehicle V is steered, as the maximum vehicle body trajectory LA. The trajectory prediction unit 13A predicts the maximum vehicle body trajectory LA in a case where the steering input value acquired by the steering acquisition unit 12 is equal to or greater than a predetermined steering angle threshold value. The trajectory prediction unit 13A can predict the maximum vehicle body trajectory LA based on the maximum steering angle of the host vehicle V set in advance. In addition, the trajectory prediction unit 13A may read out a value predicted in advance from the storage unit or the like to predict the maximum vehicle body trajectory LA.

The irradiation control unit 14A emits the trajectory guide light B corresponding to the maximum vehicle body trajectory LA predicted by the trajectory prediction unit 13A to the traveling road surface R around the host vehicle V using the projector 20A. Here, in a case where the obstacle is not detected on the maximum vehicle body trajectory LA by the obstacle detection unit 11, the irradiation control unit 14A emits the first trajectory guide light Ba from the plurality of first light sources 21Aa to the traveling road surface R.

In addition, in a case where the obstacle detected by the obstacle detection unit 11 is positioned on the maximum vehicle body trajectory LA, the irradiation control unit 14A emits the trajectory guide light B corresponding to the maximum vehicle body trajectory LA to the traveling road surface R and the detected obstacle. The irradiation control unit 14A switches the light source that emits the trajectory guide light B among the plurality of first light sources 21Aa and the second light sources 21Ab to emit the trajectory guide light B to the traveling road surface R and the detected obstacle. Here, in addition to the first trajectory guide light Ba emitted from the first light source 21Aa, the irradiation control unit 14A may emit the second trajectory guide light Bb from the second light source 21Ab such that it is irradiated onto the obstacle. Alternatively, the irradiation control unit 14A may emit the second trajectory guide light Bb from the second light source 21Ab to irradiate the obstacle instead of at least any of the plurality of first light sources 21Aa.

In a case where the first trajectory guide light Ba emitted from the first light source 21Aa is not emitted to the obstacle positioned on the maximum vehicle body trajectory LA, the irradiation control unit 14A may emit the second trajectory guide light Bb from the second light source 21Ab. In addition, even in a case where the first trajectory guide light Ba emitted from the first light source 21Aa can be emitted to the obstacle positioned on the maximum vehicle body trajectory LA, the irradiation control unit 14A may emit the second trajectory guide light Bb from the second light source 21Ab.

As described above, by irradiating the obstacle with the second trajectory guide light Bb of the second light source 21Ab, the second guide mark Mb can be displayed at a higher position on the side surface of the obstacle. In this case, the occupant (driver) of the host vehicle V can easily determine that the host vehicle V may come into contact with the obstacle.

In a case where the maximum vehicle body trajectory LA is not predicted by the trajectory prediction unit 13A because the steering angle of the host vehicle V is small, the irradiation control unit 14A does not emit the trajectory guide light B from the projector 20A. In addition, as in the first embodiment, in a case where the obstacle detected by the obstacle detection unit 11 is a person, the irradiation control unit 14A does not emit the trajectory guide light B.

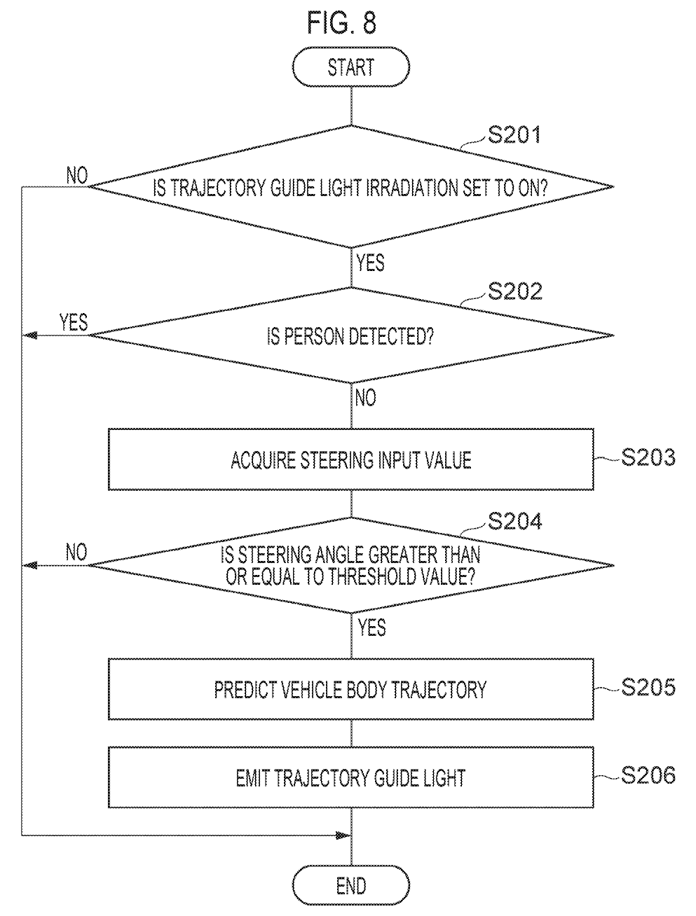

Next, a flow of the irradiation processing of the trajectory guide light B performed in the trajectory presentation device 100A will be described. The processing shown in FIG. 8 is started, for example, in a case where an ignition switch of the host vehicle V is turned on. In addition, in a case where the processing shown in FIG. 8 ends, the processing is started again from the start after a predetermined time. The processing of S201 to S203 shown in FIG. 8 is the same as the processing of S101 to S103 shown in FIG. 5, and the description thereof will be omitted.

After the processing of S203, the trajectory prediction unit 13A determines whether the steering input value acquired by the steering acquisition unit 12 is equal to or greater than a predetermined steering angle threshold value (S204). In a case where the steering input value is not equal to or greater than the predetermined steering angle threshold value (S204: NO), the processing proceeds to the end. In a case where the steering input value is equal to or greater than the predetermined steering angle threshold value (S204: YES), the trajectory prediction unit 13A predicts the maximum vehicle body trajectory LA along which the vehicle body of the host vehicle V passes in a case where the host vehicle V is steered to the maximum in the direction in which the host vehicle V is steered (S205).

The irradiation control unit 14A emits the trajectory guide light B corresponding to the maximum vehicle body trajectory LA predicted by the trajectory prediction unit 13A to the traveling road surface R around the host vehicle V using the projector 20A (S205). The obstacle detected by the obstacle detection unit 11 may be positioned on the maximum vehicle body trajectory LA. In this case, as described above, the irradiation control unit 14A emits the trajectory guide light B also to the obstacle positioned on the maximum vehicle body trajectory LA. In a case of irradiating the obstacle with the trajectory guide light B, the irradiation control unit 14A can emit the second trajectory guide light Bb from the second light source 21Ab to the obstacle.

As described above, in a case where the obstacle detected by the obstacle detection unit 11 is positioned on the maximum vehicle body trajectory LA, the trajectory presentation device 100A emits the trajectory guide light B corresponding to the maximum vehicle body trajectory LA to the traveling road surface R of the host vehicle V and the obstacle. As a result, the trajectory presentation device 100A can emit the trajectory guide light B corresponding to the maximum vehicle body trajectory LA of the host vehicle V in consideration of the possibility of contact with the obstacle around the host vehicle V.

In addition, since the light source 21A (the first light source 21Aa and the second light source 21Ab) provided in the projector 20A is fixed, the maintenance of the projector 20A is facilitated.

In addition, the trajectory presentation device 100A may be configured not to emit the trajectory guide light B in a case where the obstacle is not detected around the host vehicle V by the obstacle detection unit 11. That is, the trajectory presentation device 100A may determine whether the driver of the host vehicle V performs the steering to avoid the obstacle based on the presence or absence of the obstacle, and emit the trajectory guide light B.

What is claimed is:

1. A trajectory presentation device that emits trajectory guide light corresponding to a vehicle body trajectory along which a vehicle body of a host vehicle passes during traveling of the host vehicle in a vicinity of the host vehicle, the trajectory presentation device comprising:
a projector configured to emit the trajectory guide light in the vicinity of the host vehicle;
an obstacle detection unit configured to detect an obstacle in the vicinity of the host vehicle;
a steering acquisition unit configured to acquire a steering input value of a steering operation of the host vehicle;
a trajectory prediction unit configured to predict the vehicle body trajectory of the host vehicle based on the steering input value; and
an irradiation control unit configured to emit, using the projector, the trajectory guide light corresponding to the vehicle body trajectory onto a traveling road surface in the vicinity of the host vehicle,
wherein the irradiation control unit is configured to emit the trajectory guide light corresponding to the vehicle body trajectory onto the traveling road surface of the host vehicle and onto the obstacle in a case where the obstacle detected by the obstacle detection unit is positioned on the vehicle body trajectory.

2. The trajectory presentation device according to claim 1, wherein:
the obstacle positioned on the vehicle body trajectory that is detected by the obstacle detection unit is an object that enters the vehicle body trajectory from a side of the vehicle body trajectory in a state of being spaced apart from the traveling road surface; and
the irradiation control unit is configured to emit the trajectory guide light onto a portion of the obstacle that enters the vehicle body trajectory.

3. The trajectory presentation device according to claim 1, wherein the irradiation control unit is configured to emit the trajectory guide light corresponding to the vehicle body trajectory onto the traveling road surface of the host vehicle and onto the obstacle by changing an irradiation direction of a light source provided in the projector or switching, among a plurality of light sources disposed in the projector such that the light sources have different irradiation directions, the light source to emit the trajectory guide light.

4. The trajectory presentation device according to claim 1, wherein the irradiation control unit does not emit the trajectory guide light in a case where the obstacle detected by the obstacle detection unit is a person and the person is positioned within a distance that is predetermined from the host vehicle.

5. The trajectory presentation device according to claim 1, further comprising:
a camera configured to capture an image of the vicinity of the host vehicle; and
a display configured to display the image captured by the camera, wherein
the projector is configured to emit the trajectory guide light at a wavelength different from visible light, and
the camera is configured to detect the wavelength of the trajectory guide light emitted by the projector.
